(19) United States
(12) Patent Application Publication
(10) Pub. No.: US 2009/0030902 A1
(43) Pub. Date: Jan. 29, 2009

(54) SCHEMATIZED DATA INTELLIGENT ASSISTANCE FOR DEVELOPMENT ENVIRONMENTS

(75) Inventors: Avner Y. Aharoni, Seattle, WA (US); Henricus Johannes Maria Meijer, Mercer Island, WA (US); David N. Schach, Redmond, WA (US); Andrew Eyring Kimball, Sammamish, WA (US); Vladimir G. Sadov, Redmond, WA (US); Sravani Kothapalle, Redmond, WA (US); Ghanashyam Chandrasekhar Namboodiripad, Redmond, WA (US); Stanislav Kitsis, Snoqualmie, WA (US); Mohamed Helal, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/782,626

(22) Filed: Jul. 24, 2007

(51) Int. Cl. G06F 17/30

(52) U.S. Cl. 707/6; 707/E17.008

(57) ABSTRACT

Intelligent assistance functionality is provided in development environments and/or other editors for schematized data. Input of a trigger character sequence can initiate an intelligent assistance box having data corresponding to a related schema. Thus, the intelligent assistance data can be dynamic as schematized data can change; the data can be queried from the schema as requested to facilitate this end. In one embodiment, the data can be an extensible markup language (XML) schema having a plurality of elements. In this regard, syntax can be entered into a development environment to effectuate an intelligent assistance box comprising the elements of the schema; a root level element can be displayed for an initial trigger character sequence. After selecting the element, another trigger sequence can be input to facilitate querying the schema for next level elements, and so on.

### BACKGROUND

The evolution of computers from high-cost, low performance data processing systems to low cost, high-performance communication, problem solving, and entertainment systems has also caused software programming for computers to extend to a plethora of tasks. As computers become a greater part of life, they become easier to use and understand through the employment of many interface technologies. Likewise, programming environments have become easier to use—evolving from a plurality of switches, to punch cards, to cryptic text files, to today's technology of integrated development environments (IDE). The IDEs provide a canvas for project development allowing visual representations of software development tasks, such as drag-and-drop functionality for adding files to include in builds, an editor window with tabs to easily switch between windows, compiler output windows with stepping function to visually identify compilation errors, etc.

Another functionality of today's IDEs is intelligent assistance behavior when editing files. Such behavior provides a selection function to aid the developer in completing (and accurately typing) class names, types, members, function signatures, and the like. The developer can begin typing a class name and hit the “.” character for example, and the types, member variables, functions, and the like associated with the class pop-up in a selection box associated with the intelligent assistance. As the developer continues to type, the items in the box become more refined to what the developer may be looking for (such as through character matching, for example). The developer has the option to keep typing and ignore the intelligent assistance box or to select an item from the list.

With the evolution of the Internet, software applications are provided to access remotely located data for a plurality of users. Data intensive applications historically used relational databases to store and access data due to its rapid retrieval of such information. However, data trends are evolving toward hierarchically stored data formats as these typically provide a more intuitive storage and access of the data. In either case, schemas can be provided for the data that describe how the data is stored and accessed. The schema allows for properly conforming storage and retrieval and compliance with the developed architecture. Thus, software applications can utilize such a schema to programmatically access data knowing how the data is conformed. The schema is a specification for the stored data. Developers can access the schemas to determine data layout and write software applications that consume the data according to the layout.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Intelligent assistance functionality is provided for schematized data as well as an object type associated therewith. Schemas related to a given environment can be located and stored for subsequent access. A character sequence input into the environment can trigger the intelligent assistance functionality and send a context along with the trigger. The context can be utilized to navigate one or more related schemas and compose a list of applicable schema elements and/or attributes. The list can be transmitted to the environment for display in an intelligent assistance selection box. In one embodiment, lists can be produced for more than one schema and merged according to a similarity between elements. The merged list is submitted to the environment.

In one embodiment, the intelligent assistance functionality can be provided for the schematized data or the object type associated therewith depending on the trigger input in the environment. For example, one character sequence can cause display of intelligent assistance data associated with the object type - this intelligent assistance data can include a character sequence for opening another intelligent assistance data box having the schematized data intelligent assistance for example. Additionally, dataflow can be preserved with respect to the intelligent assistance data such that assigning variables to a schema expression can cause the appropriate intelligent assistance data for the context of the variable value to be displayed upon the trigger character sequence. Moreover, a caching mechanism can be provided for the one or more schemas.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that provides intelligent assistance functionality.

FIG. 2 illustrates a block diagram of an exemplary system that provides intelligent assistance functionality for schematized data.

FIG. 3 illustrates a block diagram of an exemplary system that provides intelligent assistance functionality for object type data and schematized data.

FIG. 4 illustrates a block diagram of an exemplary system that provides intelligent assistance functionality for data relating to one or more schemas.

FIGS. 5-10 illustrate exemplary computer interface representations of development environments providing intelligent assistance functionality.

FIG. 11 illustrates an exemplary flow chart for displaying intelligent assistance data.

FIG. 12 illustrates an exemplary flow chart for processing a request for intelligent assistance data.

FIG. 13 is a schematic block diagram illustrating a suitable operating environment.

FIG. 14 is a schematic block diagram of a sample-computing environment.

### DETAILED DESCRIPTION

Intelligent assistance functionality is provided for schematized data within an integrated development environment (IDE) to facilitate more efficient developing of software applications that utilize such data. For example, when developing software that utilizes a schematized data set, an intelligent assistance window can be displayed to allow navigation over available fields in the schematized data. This can mitigate having to look for fields in a schematized data source, which can be time-consuming and cumbersome as a function of the size and number of schematized elements in the data. Schematized data can be loaded in the development environment and can be used to populate an intelligent assistance box; the box can be displayed upon typing a character related to the schematized data. The schematized data can be hierarchical as well such that dot-notation, for example, can be used to access different levels of the hierarchy; the hierarchy can be queried upon hitting the appropriate character(s) (such as a dot) for example.

In one embodiment, the schematized data can be extensible markup language (XML) data or document. Schemas relating to the XML can be loaded in the project (or obtained by other means), and intelligent assistance boxes related to the XML data can appear upon typing a “.<” indicator, for example, to specify that an XML tag (such as a descendant tag) is desired. Additionally, for example, other indicators can be used such as “.@” to specify that a list of attributes is desired. As mentioned, when a “.<” is typed, there can be a query on the XML schemas. Once an tag is chosen, if there is another “.<” typed to specify a child node, for example, the data can be further queried to list the available children in the intelligent assistance box (if any). It is to be appreciated that the functionality can operate with dataflow such that declaring a variable equal to an XML tag can pop up the appropriate intelligent assistance box where the developer enters “variableName.<” for example. Additionally, the data can be namespaced, such as XML, and data in the intelligent assistance selection box can be organized taking namespace, or a prefix related thereto, into account. Moreover, the subject matter as described can employ caching techniques for the schematized data to provide efficient access thereto.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

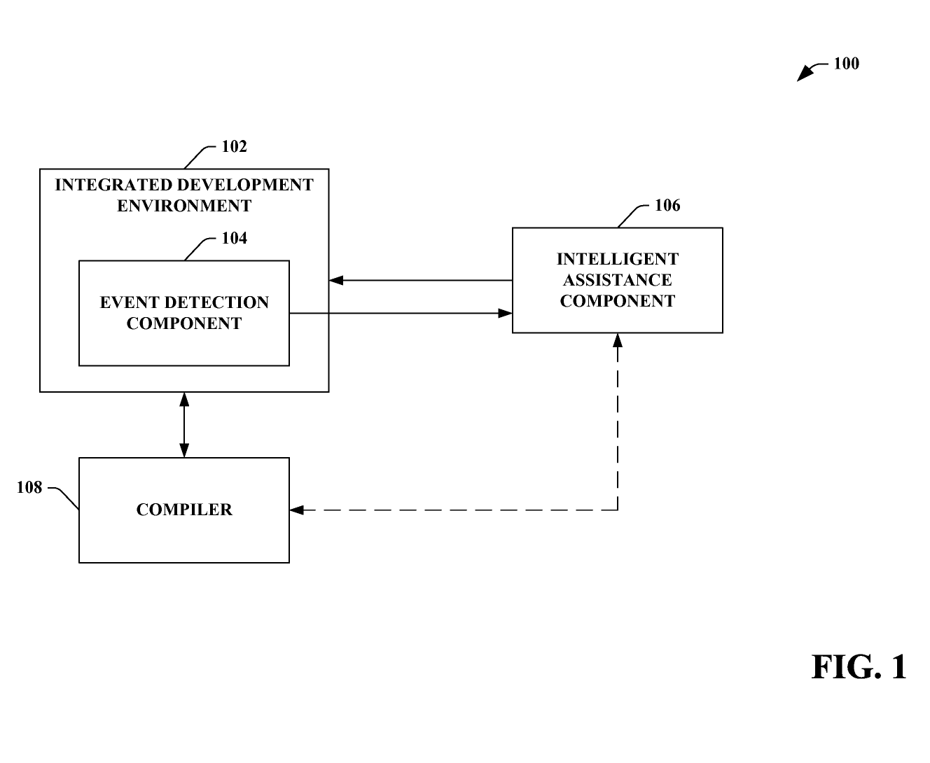

Now turning to the figures, FIG. 1 illustrates a system 100 for developing software applications. An IDE 102 is provided to allow a developer to write and design software applications, the IDE 102 has an event detection component 104 that can detect various events with respect to actions occurring on the IDE 102. An intelligent assistance component 106 is also provided to facilitate utilizing intelligent assistance technology in building the application. It is to be appreciated that the intelligent assistance component 106 can be a separate component, as pictured, or existing within the IDE 102. Additionally, a compiler 108 is displayed to compile code produced in the IDE 102 into machine-readable form. In one embodiment, the intelligent assistance component 106 can formulate intelligent assistance information based on pre-compiled information regarding classes related to the project obtained from the compiler 108. It is to be appreciated that the intelligent assistance component 106 can receive this information from other sources as well, however.

The intelligent assistance component 106 can provide intelligent assistance information and/or functionality to the IDE 102 where typing certain character sequences can cause a box to appear in the environment comprising a selectable list of items that apply to the character sequence such that the developer can select an item rather than completing the sequence by keystroke. It is to be appreciated that the character combinations that cause the intelligent assistance selection box to appear can be detected by the event detection component 104 of the IDE 102, for example. In this regard, the intelligent assistance component 106 can predict one or more possible items the developer may desire and allow the developer to select from the list. In some cases, the intelligent assistance data can relate to object-oriented items such as classes. In one embodiment, typing a dot can initiate an intelligent assistance selection box for a recognized class. For example, typing “Customer.” can cause an intelligent assistance box to display the members of the Customer class (which can be Order, Name, Address, etc., for example). As the developer continues to type, the results can be navigated as one or more results begin to match. Additionally, intelligent assistance can be used with other elements such as object-oriented language data types. For example, using a defined String type and declaring a variable stringName as type String can cause an intelligent assistance selection box to appear when typing “stringName.” for example, displaying the operations available for the String type. The intelligent assistance information, as mentioned, can come from the compiler 108, the IDE 102, and/or the intelligent assistance component 106 or a component or data store associated therewith.

In one embodiment, a hierarchical language type can be added as an available data object (such as in the compiler and/or in classes or libraries associated with the development environment or a given project, for example). In one example, a hierarchical language such as XML can be defined as a type such that in a not so strongly typed programming language, the developer can declare a generic variable and set it equal to some XML syntax, such as CurrentCustomer=“<customer number=“1199”></customer>” for example. The compiler 108 (or component thereof, such as a lexer (not shown), for example) can declare the variable as an XML type variable (or an XML object, for example). To this end, the developer can input “CurrentCustomer.” in the program listing using IDE 102, the event detection component 104 can detect the dot and query the intelligent assistance component 106 for data, for example. The intelligent assistance component 106 can send back operations relating to the XML type/object itself to be displayed in an intelligent assistance box on the IDE 102 (such as “.Child;” “.Parent;” “.AddNode;” and/or the like, for example). It is to be appreciated that other hierarchical and/or schematized language definitions can have associated types as well. Additionally, these can be types with respect to numerous programming languages, compilers, and/or runtime environments (such as common language runtime (CLR), Java virtual machine (JVM), etc.). To this end, assigning a value in the syntax of the language definition can essentially declare the variable to which the value is assigned to an object representative of the language and/or definition. This allows for special properties related to the object type to provide direct access to the hierarchical/schematized data.

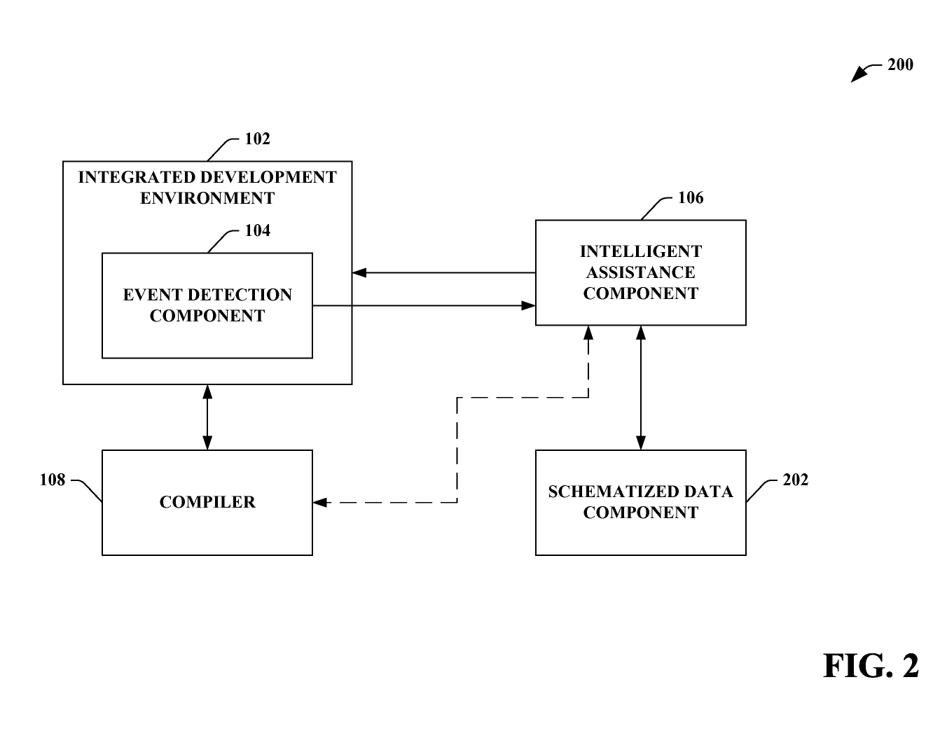

Referring to FIG. 2, a system 200 for displaying intelligent assistance data with respect to schematized data is shown. In particular, an IDE 102 is provided for coding software applications as well as an event detection component 104 that can detect one or more events associated with the coding. An intelligent assistance component 106 is also provided to aid the developer in entering class names, types, function parameters, etc. in the IDE 102, ensuring accuracy and mitigating keystrokes in some cases. A compiler 108 is shown that comprises functionality to transform program code created in the IDE 102 to machine code; one step in the functionality can be related to a lexer that can recognize lexicographic tokens in the code, for example. In one embodiment, the lexer can be used at a pre-compile step to determine one or more intelligent assistance items to be displayed upon an intelligent assistance data request, for example. It is to be appreciated that other sources for the available items can be utilized as well. Additionally, a schematized data component 202 is shown that can provide the intelligent assistance component 106 with information related to one or more schematized data strings and/or files, for example.

In one embodiment, the event detection component 104 can detect a character string (e.g. sequence of characters) entered in the IDE 102 (by a software developer, for example) and can submit the event information to the intelligent assistance component 106. Depending on the character sequence, the intelligent assistance component 106 can consult the compiler 108 or another component or local store for precompiled class information or the schematized data component 202 for information regarding actual schematized data. Thus, not only can the intelligent assistance component 106 aid the developer in specifying class names, types, function parameters, etc., but also schematized data elements. In this regard, the intelligent assistance functionality can be bifurcated for an object type system and a schema type system, for instance, such that it can operate with respect to data related to the object itself (such as member functions, types, etc. related to the object) as well as data related to a given optionally layered schema. It is to be appreciated that the trigger character sequences can be different for each type and/or the same where the different intelligent assistance data parameters can appear according to context, for example.

For example, a portion of the schematized data can relate to an XML document or an XML schema document (XSD) that can be associated with the development project. It is to be appreciated that with respect to the former, a schema can be inferred from the XML document. Additionally, the schematized data component 202 can operate with one or more other types of schematized/hierarchical data in a similar manner. In one embodiment, the event detection component 104 can detect occurrence of a character string; in one embodiment, this can be “.<” for example, which can indicate the beginning of a tag in XML. This occurrence can trigger a call to the intelligent assistance component 106 to present intelligent assistance information related to one or more available schemas, for example. The intelligent assistance component 106 can leverage the schematized data component 202 in this regard to obtain the desired information regarding the schema. As described above, an XML object type can be implemented in the development environment such that a variable can be declared as XML type. For example, a variable XDoc can be created and initialized to represent the contents of an XML file and/or schema. Typing “XDoc.<” in the development environment can cause an intelligent assistance box to appear with the tags available for selection in the related XML document. This can be caused by the event detection component 104 detecting the occurrence of the “.<” string and submitting a request to the intelligent assistance component 106 for schema data corresponding to the XML related to XDoc. In another embodiment, the data can be globally available data from one or more XML files and/or schemas, for instance.

For example, an XML file can be provided having the following general structure.

```
<Customer ID=“678”>
    <Name>John Smith</Name>
    <Order Number=“1234”>
        <Widget ID=“9”/>
        <Quantity>5</Quantity>
    </Order>
    <Order Number=...>
    ...
    </Order>
</Customer>
<Customer ID=...>
...
</Customer>
...
```

Thus, a variable, such as XDoc can be assigned to the contents of this file and/or string. When “XDoc.<” is entered in the IDE 102, the event detection component 104 can detect this occurrence and query the intelligent assistance component 106 for related XML data. The intelligent assistance component 106 can gather the necessary data from the schematized data component 202, for instance. In this example, the intelligent assistance box can display “<Customer>” as an available selection as this is the single first-level selection represented in the data. This can be selected and/or typed and can be followed by another “.<” for example, rendering the string “XDoc.<Customer>.<” This can instantiate another intelligent assistance selection box displaying the available child selections “<Name>” and “<Order>” for example. In this embodiment, the event detection component 104 can detect the second “.<⇄ and leverage the intelligent assistance component 106 to retrieve second-level intelligent assistance information. For example, the event detection component 104 can send the string, or a representation thereof, to the intelligent assistance component 106 to indicate the level of the information requested; in this example, the desire for child level tags of <Customer> can be conveyed to the intelligent assistance component 106. The intelligent assistance component 106 can utilize this information, for instance, to query the schematized data component 202 for the appropriate level data. In another embodiment, dataflow can be preserved, for instance, where a variable is set to an XML element. For instance, setting a new variable XDocElement=XDoc.<Customer>, the event detection component 104 can then detect the string “XDocElement.<” (where entered by a developer in IDE 102, for example) and send appropriate information to the intelligent assistance component 106, such as the value of XDocElement and/or a memory pointer related thereto, etc. Since XDocElement is set to XDoc.<Customer>, the intelligent assistance component 106 can return second-level (or child) tags of <Customer> to be displayed in the intelligent assistance box on IDE 102. Thus, in this example, the effect of typing “XDocElement.<” in IDE 102 can be an intelligent assistance box displaying <Name> and <Order>; in this regard, dataflow is preserved. Additionally, the sequence “.@” can also cause the intelligent assistance component to display an intelligent assistance selection box for schematized data related to XML attributes in this embodiment. Thus, “<Customer>.@” can display an intelligent assistance box for “ID” for example.

In another example, an XML schema can be provided; for example, a schema that describes the layout of an XML document such as the one shown supra. The schema can be associated with the program being developed (such as via a project workspace in the IDE 102, for example). In this regard, a variable can be declared and related to the schema such that similar behavior as described above can occur when typing the variable name and a “.<” Additionally, the variable can be related to no such schema, rather typing “.<” populates an intelligent assistance selection window with data related to other schemas available in the project or with respect to the development environment, for example. Once an element is chosen, then the list can be refined to one or more documents to which the chosen tag corresponds. In this embodiment as well, the intelligent assistance component 106 is leveraged upon detection of “.<” being typed in the IDE 102 by the event detection component 104. Additionally, the intelligent assistance component 106 can utilize the schematized data component 202 to obtain the desired information.

It is to be appreciated that the bifurcated nature of the intelligent assistance component 106 can allow object type intelligent assistance to be utilized as well. For instance, using the above example typing “XDoc.” can display an intelligent assistance window relating to the XML object itself, thus having options for “.AddNode” “.Child” “.Parent” etc. Additionally, the characters for obtaining schematized data intelligent assistance can be displayed as well (e.g. “.<” and other characters that can be utilized with respect to the schematized data). If the “.<” is chosen from the list or typed, then a different intelligent assistance box can be displayed with the schematized information as shown above. It is to be appreciated that with respect to the object type intelligent assistance, the intelligent assistance component 106 can utilize the compiler 108 to retrieve precompiled information relating to the object type, for example. Additionally, other components or data stores can be used to retrieve such information. The schematized data component 202 can be utilized by the intelligent assistance component 106 to retrieve the schematized data information, for example, when the “.” turns into “.<”

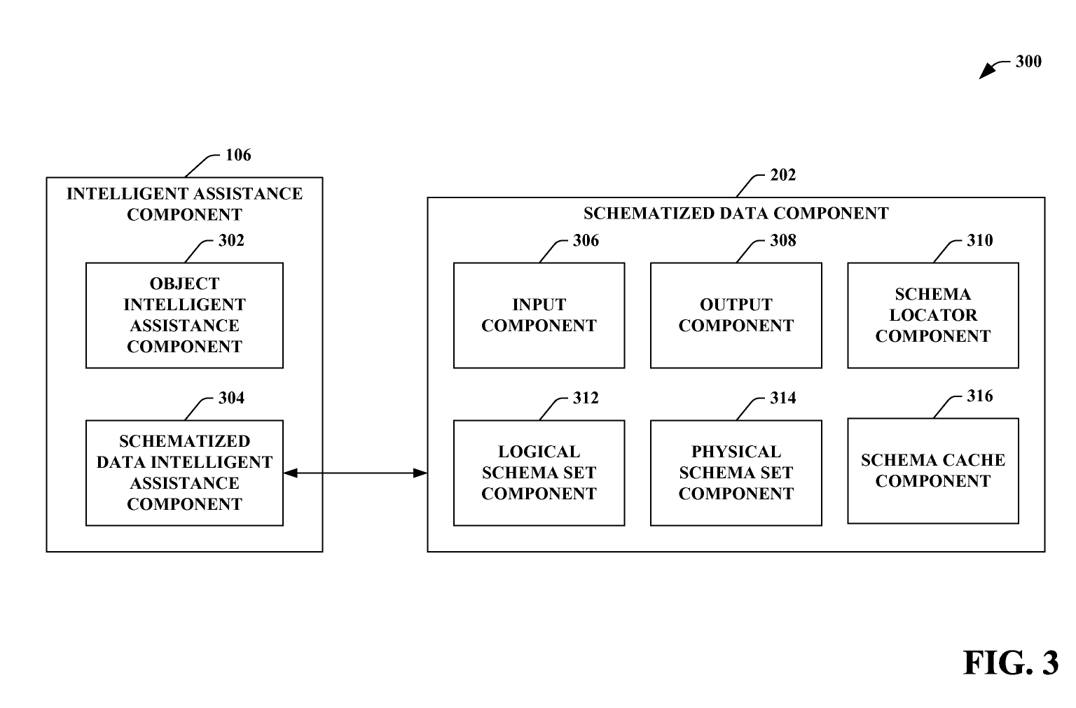

Turning now to FIG. 3, a system 300 for providing intelligent assistance functionality is illustrated. An intelligent assistance component 106 is shown for providing the capability (such as to an IDE, for example). The intelligent assistance component 106 can comprise an object intelligent assistance component 302 that provides intelligent assistance functionality related to precompiled items, such as classes, member variables, function parameters, and the like. Additionally, a schematized data intelligent assistance component 304 is provided to facilitate offering intelligent assistance functionality for dynamic-style data, such as schematized and/or hierarchical data, for instance. In addition, a schematized data component 202 can be provided to gather and expose access to a plurality of schematized data files/strings to the intelligent assistance component 106. The schematized data component 202 can comprise an input component 306 to receive requests for schematized data representations as well as an output component 308 to satisfy such requests. A schema locator component 310 is further provided to detect and determine (and store information regarding) schemas applicable to a given software development environment and/or project. The schematized data component 202 can further comprise a logical schema set component 312 that provides a collection of schemas to compile based in part on the namespaces specified in the project and/or development environment. Additionally, a physical schema set component 314 can also be provided to store the compiled schema sets specified by the logical schema set component 312. Moreover, a schema cache component 316 can be provided to cache relevant portions of requested and/or applicable schemas to provide more efficient access to the data.

The intelligent assistance component 106 can provide intelligent assistance functionality as described above for object data (such as static data related to classes of a programming languages and/or libraries related thereto) and schematized data, which can be dynamic in nature. Such functionality can be provided as described supra with respect to previous figures, for example. To provide intelligent assistance for schematized data, the schematized data intelligent assistance component 304 can leverage the schematized data component 202. In one embodiment, the intelligent assistance component 106 can receive an event for which intelligent assistance data is sought. The event can seek schematized data intelligent assistance, and thus, the intelligent assistance component 106 utilizes the schematized data intelligent assistance component 304 to provide such access. The schematized data intelligent assistance component 304 can, for example, leverage the schematized data component 202 to obtain relevant data to send back to the requesting entity. The input component 306 can receive the request from the schematized data intelligent assistance component 304, for example. This can be a request/response and/or a subscription request, for example (where the data requested is large and/or needs to be located/compiled, for instance). Thus, once the request is received, the schema locator component 310 and/or the schema cache component 316 can be queried for data related to the hierarchical document, element, and/or attribute requested. The request can comprise specific data regarding a certain schema, for example, or general data where information about generic schemas available in the system can be returned, for example.

The schema locator component 310 can be utilized to locate schemas as specified in a project development environment, such as an IDE, and/or general schemas. The general schemas can be truly generic and/or related to the project; the relation can be specified and/or determined using inference (e.g. similar projects and/or requests), for example. Additionally, schemas can be specified according to different granularities. For example, using every available schema for a given program can be one end of the granularity spectrum and using only specified schemas at the other end. The subject matter as described can have different granularities of access such to provide different schemas to different portions (methods, types, etc.) of a program application. Relevant schemas can be determined using inference as well as information in the project and/or files associated therewith, for example. Information regarding the located applicable schemas can be sent to the logical schema set component 312. The logical schema set component 312 can send information regarding compiling the schemas to the physical schema set component 314 which can perform such compilation such that the compiled schema information can be sent to the schematized data intelligent assistance component 304 via output component 308 for further use thereof. Additionally, the physical schemas, or information relating thereto, can be cached in the schema cache component 316. It is to be appreciated that this component can be separate from the physical schema set component 314 as pictured, or implemented within the physical schema set component 314, etc.

In one embodiment, the schematized data can be XML data such that the intelligent assistance component 106 is contacted upon detection of a “.<” string, for example. The schematized data intelligent assistance component 304 can be leveraged in this regard as described. The schematize data intelligent assistance component 304 can receive information regarding the entire string, for example, as well as data related thereto (such as a value of the related object, the value can indicate one or more related XML files and/or schemas). The input component 306 of the schematized data component 202 can receive the information from the schematized data intelligent assistance component 304 and return the appropriate schema data. Specifically, the logical schema set component 312 can be utilized to determine if one or more applicable schemas are compiled in the physical schema set component 314. If so, the schemas are returned through output component 308. If not, the schema locator component 310 can be utilized to retrieve the desired schema(s). Additionally, the schema cache component 316 can ensure the most recent available schema is compiled in the physical schema set component 314. If not, updated schemas can be retrieved and recompiled before providing the schema data to the schematized data intelligent assistance component 304. Once the schematized data intelligent assistance component 304 has the appropriate schema data, it can return a portion of the data to the requesting entity to facilitate intelligent assistance functionality, for instance.

In one embodiment, the following pseudo-code can be used to define one or more classes/methods related to implementation of the schematized data component 202, for example.

```
abstract class SchemaServices {
  public virtual abstract IList<SchemaLocation> GetKnownLocations( );
  public virtual abstract IList<SchemaLocation>
GetProjectLocations(Guid projectGuid);
  public virtual abstract SchemaSetBuilder CreateSchemaSetBuilder( );
}
```

This can be, for example, a class exposed by the development environment and/or an intelligent assistance component 106 for implementation of intelligent assistance with respect to schematized and/or hierarchical data. The GetKnownLocations function signature in the foregoing example can return a list of locations monitored by the schematized data component 202; for example, this can be a list of schemas in the logical schema set component 312 (and/or a list of compiled schemas in the physical schema set component 314). The schemas can be files existing in locations known to the schematized data component 202 such as in a schema directory, a directory related to the development environment, a directory of local ID files, and/or the like. In an XML or XSD embodiment, the files can have a “.xml” and/or “.xsd” extension, for instance. The object identifications and order of such can be returned substantially identically across different method calls; in this regard, a calling entity can know whether the set of locations is the same (for cache updating, etc.). The GetProjectLocations function signature can relate to returning a portion of known locations corresponding to the development project (by addition thereto, for example). In one embodiment, the files can be referenced by a catalog that is part of the project, for example. These can be part of the logical schema set component 312 and/or the physical schema set component, for instance. The objects and order can be the same such as with the GetKnownLocations function as described, for example. The CreateSchemaSetBuilder functional signature can be implemented to create one or more instances of a schema set builder class used to obtain a self-contained set of schemas to be compiled as a unit.

An example implementation for building a schema set in an XML editor environment for extensible stylesheet language languages (XSLT) utilizing the class can be represented by the following pseudo-code, for instance. This code can utilize the schematized data component 202.

```
// Obtain the service
SchemaServices schemaServices =
site.GetService(typeof(XmlEditor.SchemaServices));
// Create the builder and initialize it with starting
// locations and auto-association candidate list
// Note that the physical location of the Xslt schema
// will be discovered automatically
SchemaSetBuilder builder = schemaServices.CreateSchemaSetBuilder( );
builder.Roots.Add(new
SchemaLocation(“http://www.w3.org/1999/XSL/Transform”, null));
builder.Candidates = schemaServices.GetKnownLocations( );
// Compile the XmlSchemaSet (dispose it when finished
// so that it can be reused)
using (LockedSchemaSet locked = builder.CompileSet( )) {
    // Do not use the locked.SchemaSet outside the scope of the
    // “using”
    DoSomething(locked.SchemaSet);
}
```

As shown, a lock can be used to ensure the schema set is locked temporarily for use so updates can be avoided during the use. However, it is to be appreciated that this feature is not necessary in such an implementation.

The SchemaLocation class utilized in the foregoing example can, for example, represent schema location comprising a namespace (such as a target namespace in an XML environment) and a physical location (such as a uniform resource identifier (URI)). This class can be implemented as part of the schema locator component 310, for example, and can initially check a URI for the schema; if the schema is not there and/or is invalid, a schema can be searched for which implements the target namespace at the URI, for example. The class and location information can be immutable such that an application utilizing the class can know when locations and/or other information have changed. In one embodiment, where the schema does not exist at the URI, client-provided schema lists can be searched as well as explicit references in the client-provided schema, for example.

Obtaining a SchemaSetBuilder from the CreateSchemaSetBuilder call shown above provides a self-contained set of schemas to be compiled as a unit (such schemas can be part of the logical and/or physical schema set components 312/314).

A SchemaSetBuilder class can implement a plurality of functions to utilize in retrieving set information. For example, a GetSet method can be provided with the following function signature.
public virtual abstract IList<ResolvedSchema> GetSet( )
This function allows discovery of a set of schemas to be compiled; however compilation is not required for this method. Other functions are available as well such as CompileSet which can have the following signatures, for example.

public virtual abstract LockedSchemaSet CompileSet(
IList<ResolvedSchema> schemas)
public virtual abstract LockedSchemaSet CompileSet( )

This method can compile the results returned from a GetSet call. Additional methods can include a Roots method that stores and returns a list of root locations that can be traversed (along with imported and included files/locations) to construct a final set as well as a Candidates method to return a set of target namespace locations where they are not provided in the Roots return value, for example.

Another method that can be provided in one embodiment is a Resolver method having the following signature.

public virtual SchemaResolver Resolver {get; set;}
This function can, for example, abstract a local storage mechanism for a given schema, such as when compiled in the physical schema set component 314, for example. Additionally, the resolver can keep a cache of previously resolved schemas, and can thus be partially implemented as the schema cache component 316. In one embodiment, the resolver can provide a reference count to determine when cache can be refreshed (when reference count is 0, for example). The SchemaResolver class can offer a method to obtain and release a resolved schema, for example; getting the schema can cause an increment in the reference count, and the release method can decrement. In one embodiment, the get method can return a ResolvedSchema class instance. This class can abstract a storage mechanism of a schema; for example, it can return the schema in a requested type, a location of the schema, references—such as imports and includes—in the schema, and errors that can occur during schema resolution. In one embodiment, the method to get the actual schema can be created for a plurality of return types.

As described, a LockedSchemaSet can be implemented as well such that only one caller can use the set at a time. This ensures exclusive access to the schema, for example. In one embodiment, a series of exception handlers can be implemented, such as for errors in building schemas as well as in returning and/or disposing of schemas. For example, one such exception handler can identify a schema that references an invalid file for reporting and/or repair. Exceptions and errors can be displayed in IDE 102, for example; clicking on the error message can pull up the schematized data file as well and point out where the error has occurred, for instance. Additionally, as described, the schemas can be cached in the schema cache component 316. In one embodiment, the schemas can be loaded from cache to the logical and/or physical schema set components 312/314 by first detecting the local schema directory path (such as by resolving an identification variable, for example), loading the local schemas in the path, and for target namespaces not located, search a non-local schema cache folder or component. In one embodiment, the schema cache component 316 can implement an intelligent scheme for updating the cache. For example, the cache updating can be tied to a window focus such that when a developer changes focus to an implementation window, the schema cache component 316 can determine if the schemas in the cache require updating (e.g. if the schemas are dirty).

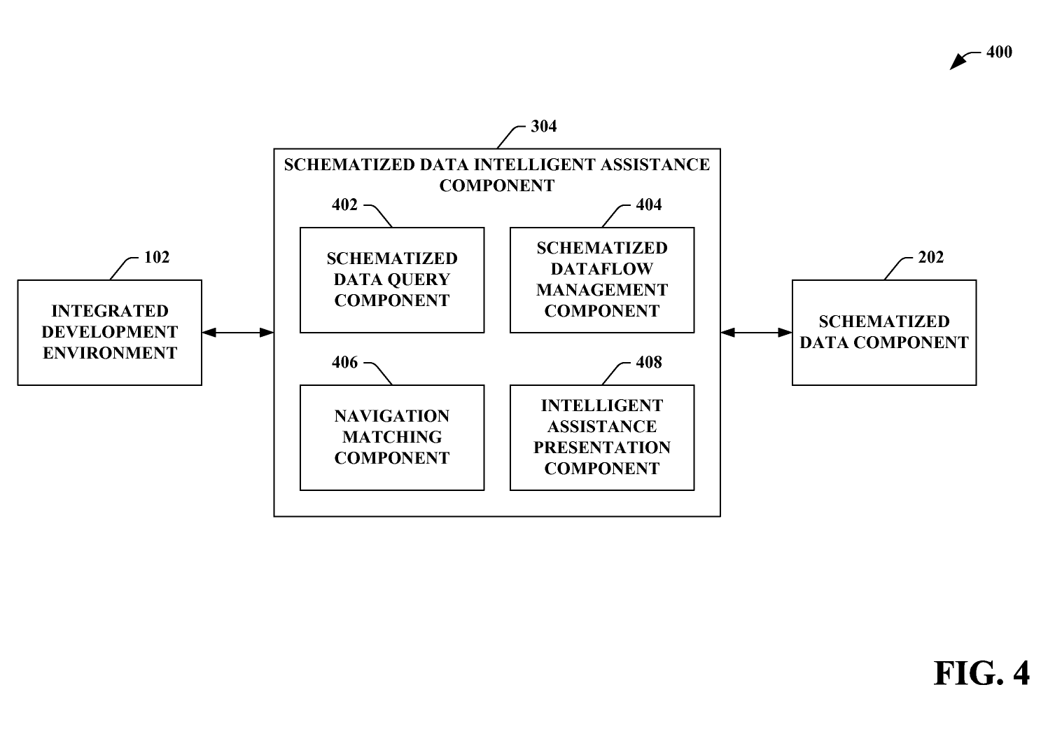

Referring now to FIG. 4, a system 400 that facilitates providing intelligent assistance functionality for schematized data is displayed. An IDE 102 is shown that provides an interface for software developers to write program applications. Intelligent assistance can be provided, as described above, for objects as well as schematized data by utilizing the schematized data intelligent assistance component 304. This component 304 can leverage the schematized data component to receive data about available schemas, for example. The schematized data intelligent assistance component 304 can comprise a schematized data query component 402 that can search one or more schemas for applicable intelligent assistance box entries that can depend upon information provided in the IDE 102, for example. Additionally, a schematized dataflow management component 404 is shown that can ensure intelligent assistance flows throughout the IDE 102, an intelligent assistance presentation component 406 that presents relevant intelligent assistance entries, and a navigation matching component 408 that supports intelligent entry gathering with respect to namespace support, for example, are also displayed as components of the schematized data intelligent assistance component 304.

In one embodiment, the IDE 102 can detect a character sequence that indicates an intelligent assistance box can be displayed to facilitate aiding the developer in writing desired software code. The character sequence can indicate use of schematized data, for example, such that the IDE 102 can provide information to and receive schematized data intelligent assistance information from the schematized data intelligent assistance component 304. In one embodiment, the IDE 102 can provide information related to characters before the detected sequence. For example, in XML the sequence can be “.<” to indicate that XML data is being utilized and thus an intelligent assistance selection box for the schematized XML data can be displayed. Thus, the characters before the sequence can indicate a tag, document, and/or variable related thereto such that the intelligent assistance data desired can be identified. For example, a variable can be defined to correspond to an XML schema object type. To this end, the variable name and a “.<” can be entered into the IDE 102 and a request can be submitted to the schematized data intelligent assistance component 304 for schematized data intelligent assistance. The IDE 102 can send information related to the variable, for example, such as the schema and/or element thereof to which it relates. Using this information, the schematized data query component 402 can query the schema to determine relevant tags/attributes to send back to the IDE 102. In one embodiment, the schematized data component 202 can be accessed to ensure the correct schema information is obtained. Subsequently, the schematized data query component 402 can search through the schema. For example, a variable can be set to correspond to an XML schema having <Customer> root nodes, as shown above, along with <Name> and <Order> tags underneath (e.g. as children). Thus, typing the variable name followed by “.<Customer>.<” can cause the schematized data query component 402 to query into the <Customer> element of the schema and locate available children, which can be <Name> and <Order> in this case.

In one embodiment, the schematized data query component 402 can search a schematized document to formulate intelligent assistance data upon request for such. Intelligent assistance data can relate to one or more items in the data. For example, in XML, intelligent assistance can be provided for tags and attributes. Each can have a different intelligent assistance request trigger as well. For example, as described, tag intelligent assistance can be triggered by “.<” additionally, attribute intelligent assistance can be triggered by “.@” Thus, when a document has attributes in certain elements, “elementName.@” can cause a list of attributes to be displayed in an intelligent assistance box on the IDE 102, for example. Additionally, the schematized data query component 402 can index data related to schematized data to facilitate efficient retrieval of such data, for example. Furthermore, the schematized data can be separated into groups. In XML, for example, information related to root elements in a document can be stored and utilized for intelligent assistance. Also, immediate children of the root elements can be stored along with group items related to other elements and attributes that are not root elements. Moreover, elements and attributes available for a given schema and related to children or descendants of schema elements/attributes can be stored as well.

The schematized dataflow management component 404 can provide schematized data intelligent assistance functionality for many aspects of an IDE 102. Furthermore, the data can be flowed through expressions like a data structure to facilitate accessing. For example, map data can be stored in a hierarchical schema such as by continent, then by country, then capital, etc. Thus, the schematized dataflow management component 404 can ensure that the expressions can be accessed as continentlcountrylcapital, for example. Thus, if a variable is assigned to continent, typing the variable name plus “|” in this example, the schematized dataflow management component 404 can ensure the intelligent assistance box appears at least with country as a selection. As another example, setting a variable equal to an XML element in the schema, a character sequence “.<” can be input following the variable name, and the next level of available elements can be displayed. In the example above, a variable nodeelement can be assigned to the <Customer> element of the XML file. Then, inputting “nodeElement.<” can render an intelligent assistance selection box with the <Name> and <Order> tags, for example. Additionally, setting a new variable tempelement=nodeelement can render the same intelligent assistance box for the character string “tempElement.<” in the IDE 102. Besides variable declaration, it is to be appreciated that other language constructs, such as method parameters, transitive expressions (such as dim y=book.<title>, for example), iteration variables (such as in a for-each construct), etc. can also trigger intelligent assistance.

The navigation matching component 406 can provide for ordering and merging of one or more lists of intelligent assistance entries before presentation thereof. In one embodiment, similar entries of the lists can be provided having different partitions based on common properties of items in the list (e.g. lists according to a namespace, prefix, or other technologies). For instance, XML allows namespaces to be assigned prefixes typically to mitigate having to type an entire XML namespace name (which can be quite long) when accessing a variable and/or tag related to the XML. Thus, in one example, an XML namespace can be defined as http://company.xml.foo and a prefix, bar, can be assigned to the namespace. To access an element, elementTag, in the XML document, the syntax bar:elementTag can be used, for example. In one embodiment, two or more XML documents and/or namespaces can have the same element and/or attribute. In this embodiment, the elements can be displayed next to each other in an intelligent assistance selection box. For example, another namespace http://company2.xml.foo can relate to a prefix, test, and also have an element elementTag. The character sequence “.<e” can be typed in the IDE 102 and the navigation matching component 406 can pair bar:elementTag and test:elementTag together in the intelligent assistance list to be presented even though there can be other available nodes that are alphabetically between the two (indeed, local tags that start with the letter “e”) and neither starts with the letter “e” when taken with the respective prefix. It is to be appreciated that if there were other namespaces that defined the same element, they can be listed near the other two and in between them in some cases as well. In this regard, lists can be generated for disparate available schemas having disparate namespaces, for example, and merged or matched according to some criteria (such as similar element names as described). Additionally, the namespace can be typed; in the example, typing “.<b” can cause the bar:elementTag to be displayed (along with other elements if applicable). To this end, if the full namespace and colon is typed, “.<bar:” the elements of the namespace can be displayed, for example.

The intelligent assistance presentation component 408 can present the chosen schema data to the IDE 102, for example. The chosen data can be presented in an intelligent assistance box providing the developer with a list of inferred data to select from. The list can refine as the developer continues to type, for example. In one embodiment, the character string “.<” can be typed causing an initial intelligent assistance box to show; the items in the box can be determined as described herein (e.g. from one or more schema data files related to the character sequence) and the intelligent assistance presentation component 408 can present the items to the user. In one embodiment, the initial box can show the elements a:Apple, Amaz:American, Amaz:space, and Bar:amir upon detecting the opening character sequence. Another character can be input at the IDE 102 and information regarding such can be sent to the schematized data intelligent assistance component 304 for processing. For example, the character “a” can be typed causing the intelligent assistance presentation component 408 to refine the results in the intelligent assistance box to conform to the new character. In this examples, all of the entries still apply (even Bar:amir, as shown above, due to the functionality in the navigation matching component 406). To further the example, an “m” can be typed as well causing the entries except for a:Apple to be sent by the intelligent assistance presentation component 408; then typing an “i” can cause the Bar:amir entry to remain in the box.

Real-time access(or near real-time) can be desired in this context as the intelligent assistance box can appear shortly after the character sequence is input to offer the intelligent assistance functionality before or as the developer types the next keystroke. In this regard, caching and/or indexing schemes can be used by the schematized data query component 402 and/or the schematized data presentation component 408 to facilitate efficient access. In one embodiment, the intelligent assistance box can appear and be populated with intelligent assistance information as the developer is interacting with the box. Thus, the intelligent assistance data can appear incrementally during typing.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

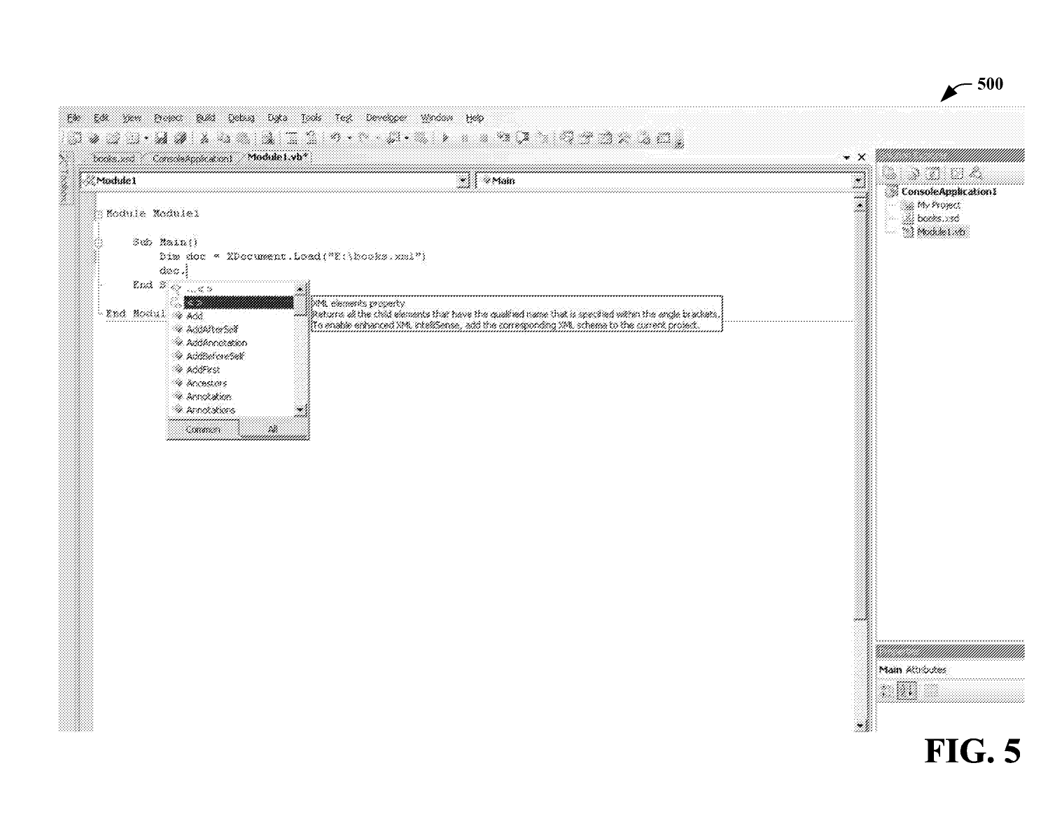

FIG. 5 illustrates an example development environment 500 in accordance with embodiments described herein. Specifically, an XSD file, books.xsd, is associated with the project. In this illustration, object type intelligent assistance is shown where the string “.” is detected and an intelligent assistance box displayed offering the methods related to the object type (XDocument) for selection. It is to be appreciated that one of the selections is “<>” which shows the availability of the XML schema intelligent assistance.

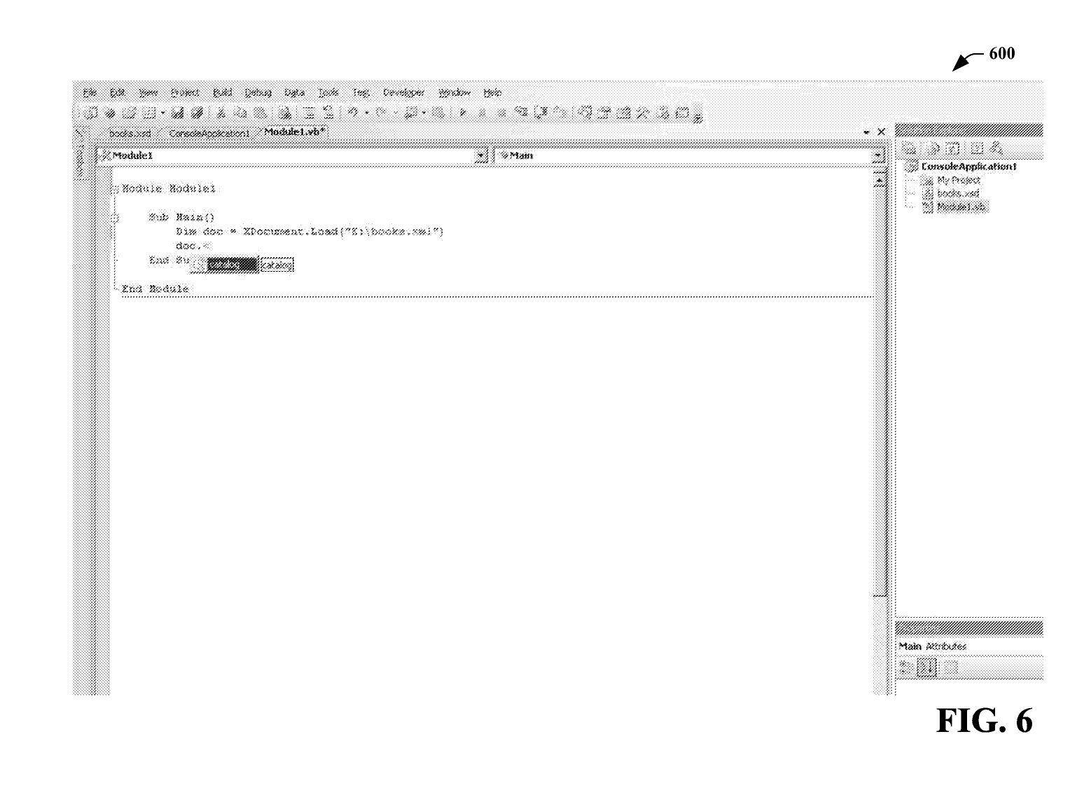

FIG. 6 shows an example development environment 600 where schema type intelligent assistance is shown related to the books.xsd file. The character string “.<” is input after the doc variable causing the schema type intelligent assistance box to appear populated with root node tags (which is <catalog> in this illustration).

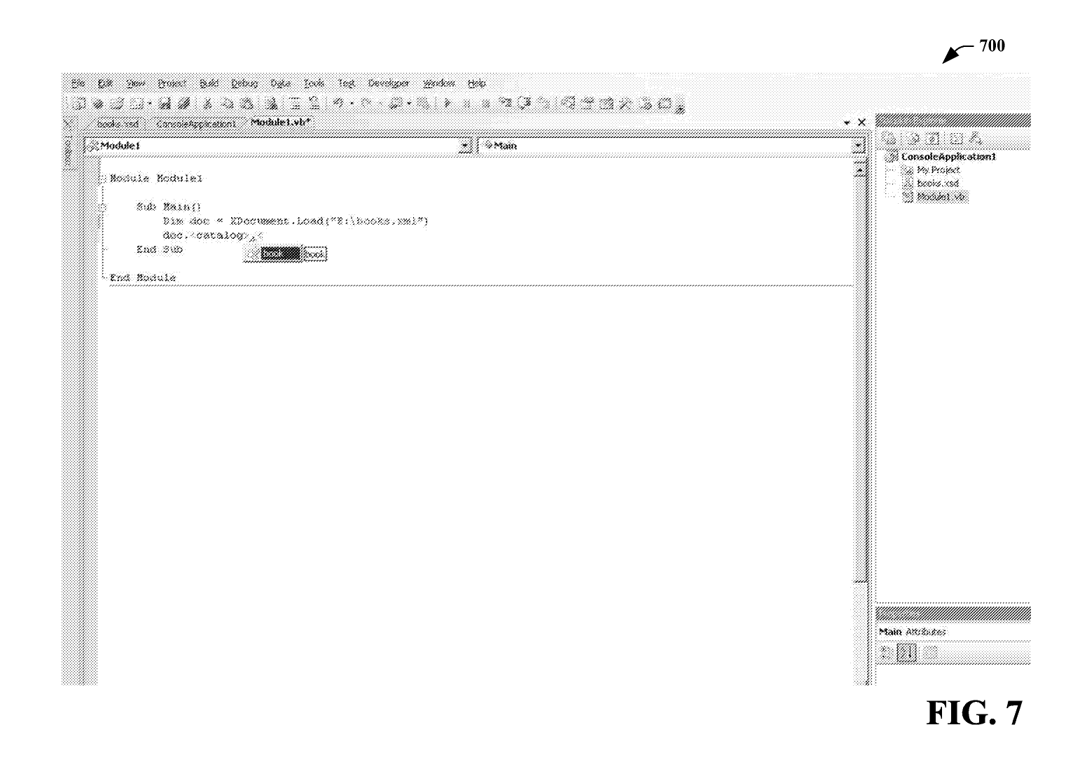

FIG. 7 displays an example development environment 700 where additional schema type intelligent assistance is shown related to the books.xsd file. In this figure, the <catalog> tag was selected and another “.<” was input causing a query on the books.xsd file to receive <catalog>'s child tags. In this example, <book> can be the only available tag in the books.xsd schema having <catalog> as a parent.

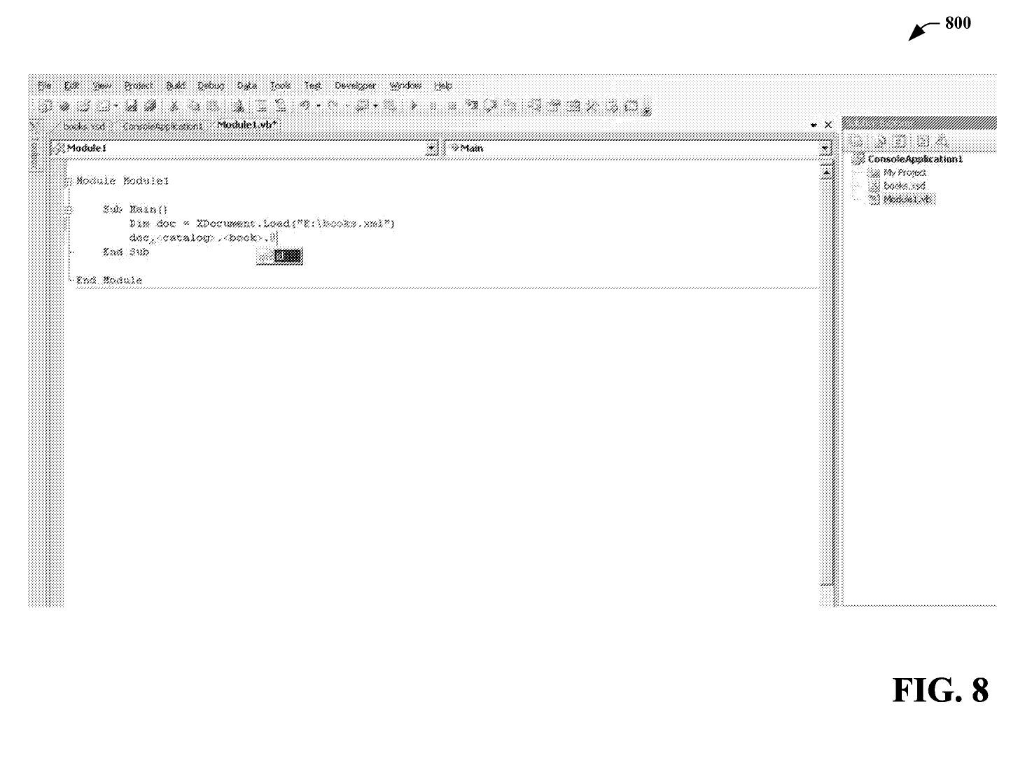

FIG. 8 shows an example development environment 800 where <book> was selected to render the string doc.<catalog>.<book> and a “.@” was typed at the end to initiate an intelligent assistance box for selections related to attributes of the tag. In the books.xsd schema, the <book> element can have an id attribute; thus, the intelligent assistance box displays this attribute.

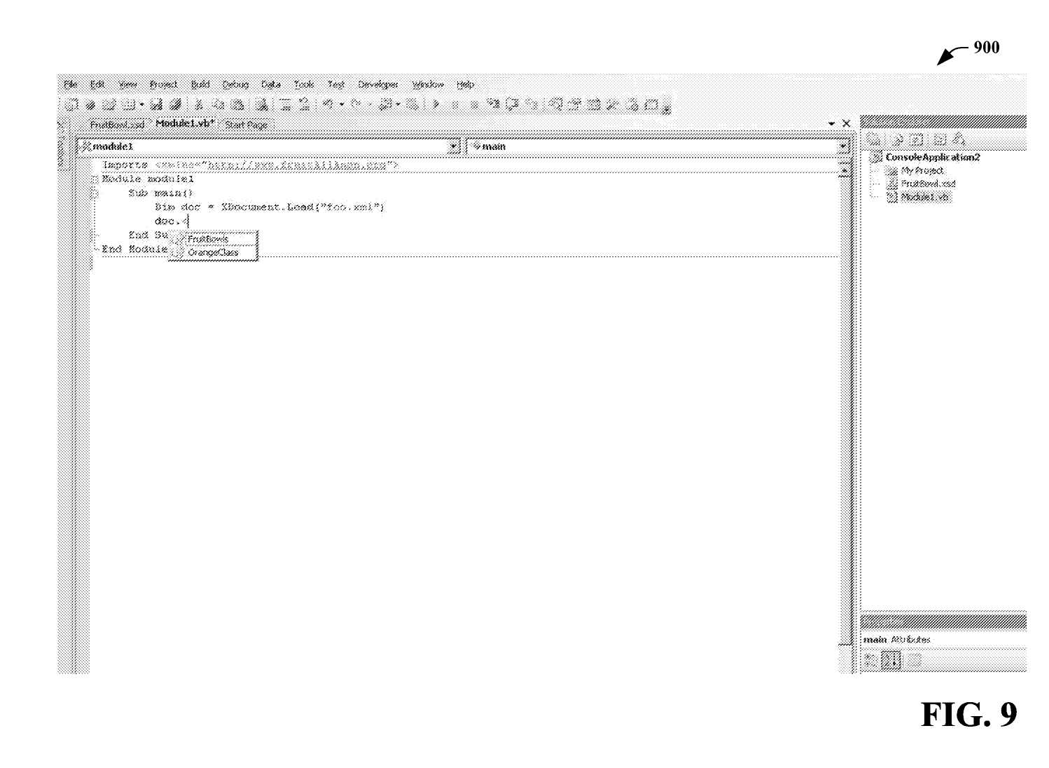

FIG. 9 illustrates an example development environment 900 that supports schematized data intelligent assistance for a remotely located schema. In particular, a namespace can be imported, such as http://fruitAllAnon.org, having one or more schemas with root level nodes FruitBowls and OrangeClass in the namespace. Thus, when the character sequence “.<” is detected, the intelligent assistance box is appropriately populated with the root level nodes.

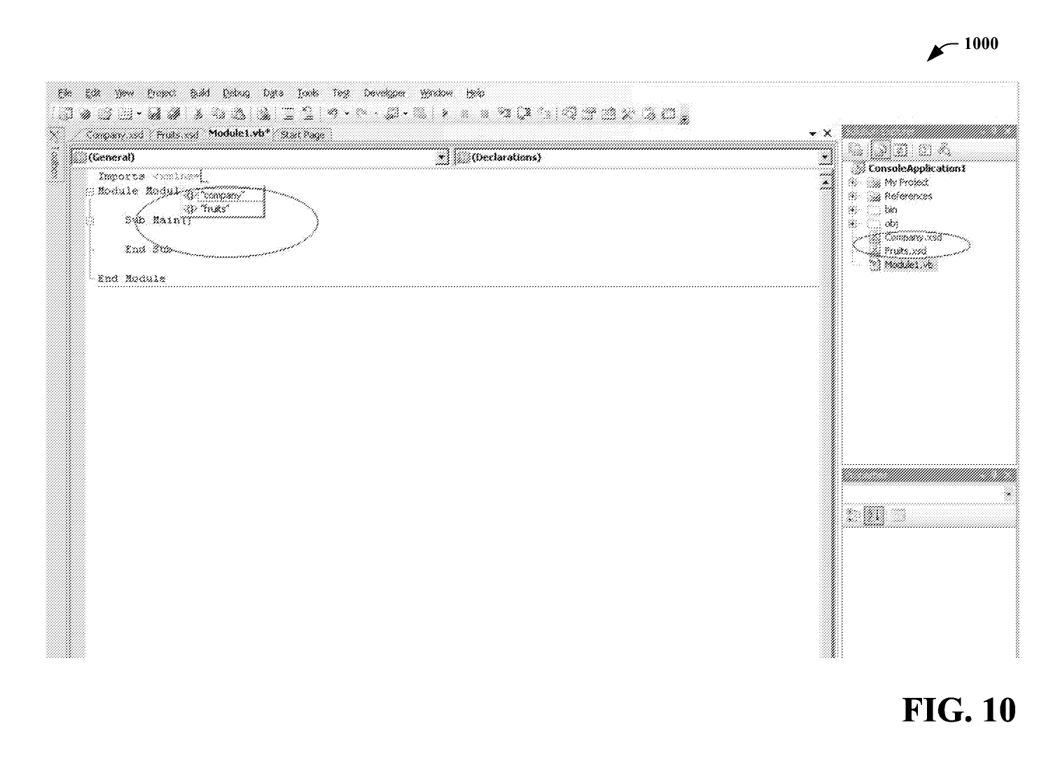

FIG. 10 displays an example development environment 1000 that has associated XSD files. In this figure, an import of an XML namespace is sought and the intelligent assistance offers the associated XSD files as options. Once imported, the intelligent assistance can proceed to populate intelligent assistance boxes for schematized data with the data from the XSD.

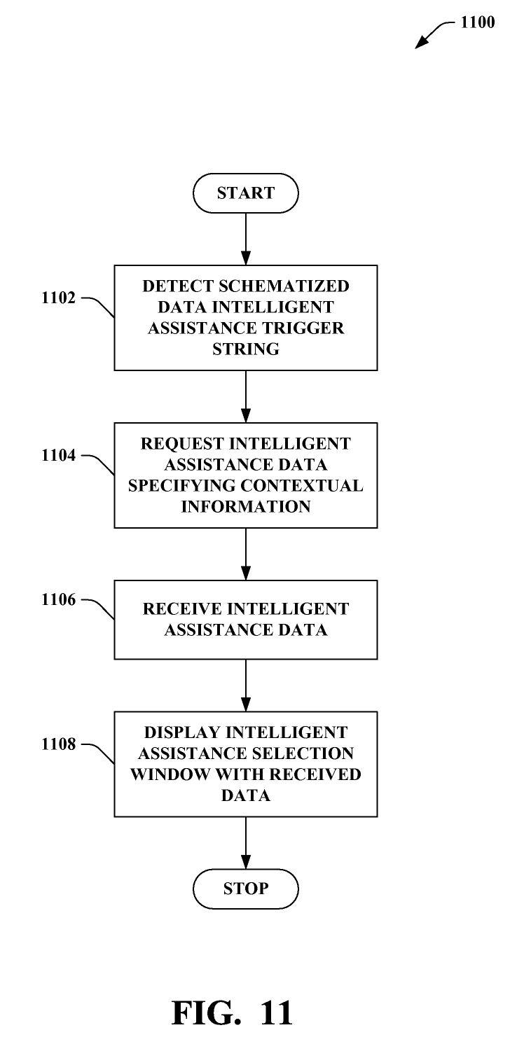

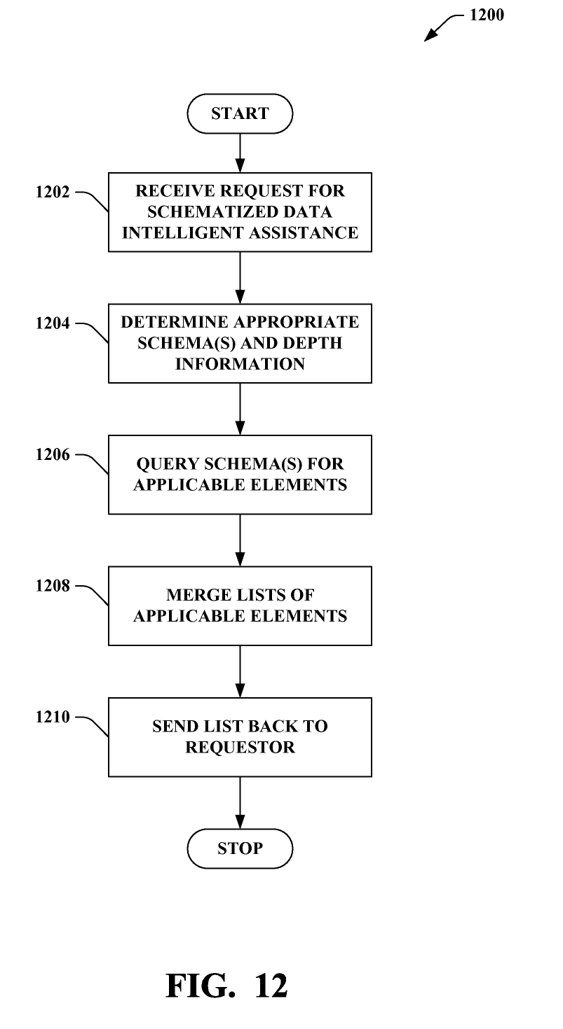

In view of the exemplary systems described supra, methodologies that may be implemented in accordance with the disclosed subject matter will be better appreciated with reference to the flow charts of FIGS. 11-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 11 shows a methodology 1100 for requesting intelligent assistance for schematized data. This can take place, for example, with respect to an IDE or other editor. In one embodiment, the editor can have one or more associated schemas related to the schematized data; the schemas can be specified by a developer and/or loaded in conjunction with the editor, for example. At 1102, a schematized data intelligent assistance trigger string is detected. This string can relate to the schematized data, for example. When the string is typed in an editor, it can be a trigger to request intelligent assistance functionality. As described, a trigger for an XML schema in one embodiment can be “.<” where typing the trigger causes a request for intelligent assistance data related to one or more specific XML schemas (and not necessarily XML generally as an object, for example). Though it is to be appreciated that information related to XML as a type can be displayed in conjunction with a different or the same trigger string. At 1 104, the request is sent for intelligent assistance data; the request comprises some contextual information as well. The trigger string can be preceded by other data, for example. In one embodiment, the data before the trigger can be related to one or more schemas and/or elements within certain schemas.

For example, map data can be provided in a hierarchical format. A schema can be discerned in the format continent/country/capital/etc. having nested elements that relate to their respective parent elements (such as North America/US/Washington, D.C., for example). Thus, if“.<” was the trigger and “.<continent>.<” was typed, the context information can be the schema file (if known, for example) as well as the preceding string of “.<continent>” As will be described, this allows the specified schema (and/or other schemas) to be queried from the <continent> element to obtain child elements. For example, other than country, area, bordering continents, climate, and other elements can exist as children of continent. At 1106, the intelligent assistance data can be received by the development environment and/or editor. The information can comprise one or more intelligent assistance elements related to the context provided; additionally the elements are not required to be specified. For example, the data can comprise elements from other schema files determined during retrieval. At 1108, the intelligent assistance window can be displayed allowing for selection of desired data. It is to be appreciated that typing additional characters after the intelligent assistance box appears can cause the list to be refined, for example; the refining can be done at the editor/development environment and/or by another intelligent assistance retrieval, for example.

FIG. 12 illustrates a methodology 1200 that facilitates formulating intelligent assistance data upon request. As described, programming environments and editors can provide intelligent assistance functionality to aid developers in creating applications and files. Intelligent assistance can be initiated based on one or more character sequences input into the editor or environment, for example. Upon receiving such, an environment can request intelligent assistance data, in one embodiment. It is to be appreciated that the subject matter as described is not limited to this embodiment; rather request for intelligent assistance data can come from substantially any entity for substantially any reason. At 1202, a request for schematized data intelligent assistance is received. The request can specify one or more schemas from which to gather the information. Additionally or alternatively, one or more relevant schemas can be determined based on other information provided (such as project information, for example) as well as inferred from previous requests and/or determined from a global and/or catalog listing. At 1204, the appropriate schemas and depth are determined. For example, the request can specify information regarding context, such as a string of elements, and one or more schemas can be queried with such information to determine a set of related elements (tags and/or attributes, for example). In one example, an XML schema can be provided, and the request can specify a one or more elements already present in a string. For instance, given an XML document/schema as described above having a plurality of <Customer> tags with <Name> and <Order> children, the request can specify the string is at the <Customer> level; thus a return of the possible elements from <Customer> is desired. It is to be appreciated that depending on context (such as the trigger used), the child elements <Name> and <Order> can be returned and/or the attribute, ID. This can occur at 1206—the schema(s) are queried for applicable elements.

At 1208, one or more lists of applicable elements can be merged. As described above, namespace functionality can be implemented for the schematized data. Thus, applicable schemas can have similar elements and different namespaces. For example, a schema can be provided having a schema relating to continents/countries/capitals, and one can have a schema relating to continents/countries/bodies of water. Thus, querying for “<continent>.<” can render at least two of the same results—those of the mentioned schemas. The schemas can be namespaced to separately identify the similar elements. According to one embodiment, the subject matter as described can locate both options and put them near each other in a list, though they relate to different namespaces. Due to the different namespaces, the elements can have different alphabetical identifiers (for example, if the namespace or a prefix associated therewith precedes the element name). However, the elements can be merged to near positions in a list at 1208 for easier identification to the user of the intelligent assistance data. At 1210, the list is sent back to the requesting entity.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

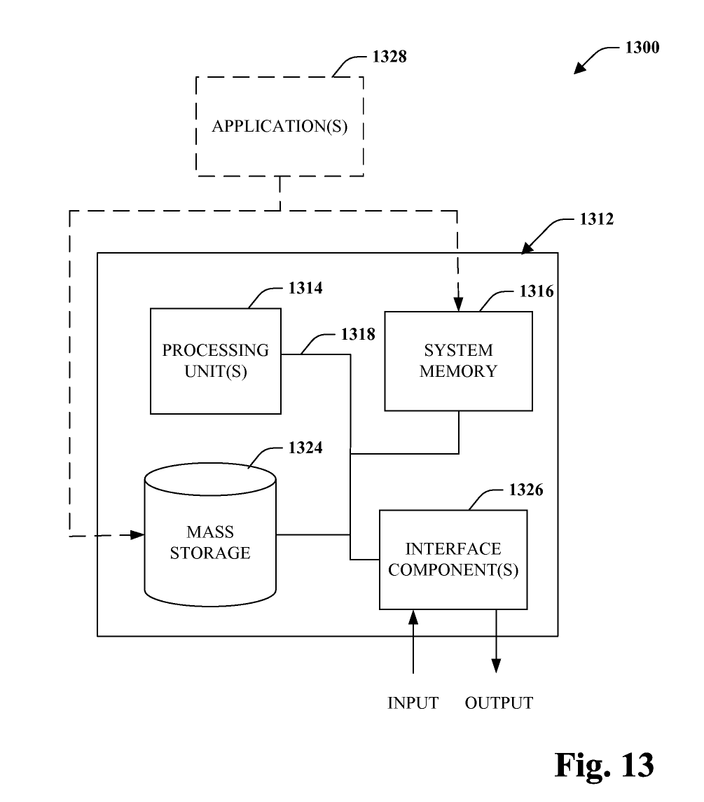

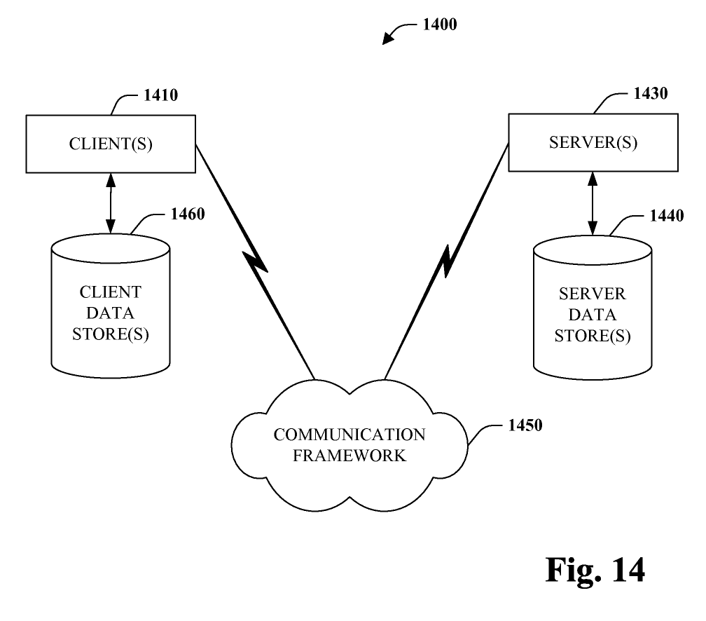

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1300 for implementing various aspects disclosed herein includes a computer 1312 (e.g., desktop, laptop, server, hand held, programmable consumer or industrial electronics . . . ). The computer 1312 includes a processing unit 1314, a system memory 1316 and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory or memory stick. In addition, mass storage 1324 can include storage media separately or in combination with other storage media.

FIG. 13 provides software application(s) 1328 that act as an intermediary between users and/or other computers and the basic computer resources described in suitable operating environment 1300. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. Here, the client(s) 1410 can correspond to program application components and the server(s) 1430 can provide the functionality of the interface and optionally the storage system, as previously described. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

By way of example, a schematized data intelligent assistance component can operate as a client 1410 and desire access to one or more server(s) 1430 for access to schemas related to the data. The schemas can be stored in a data store 1440, for example, at server(s) 1430. The request can be made from the client 1410 to the server(s) 1430 over a communication framework 1450. The client 1410 can cache the schema information in data store 1460, for example and provide intelligent assistance data based on the schema to one or more other entities.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for providing intelligent assistance functionality, comprising:
a schematized data component that determines at least one schema relating to a portion of schematized data; and
a schematized data intelligent assistance component that employs an intelligent assistance box functionality that facilitates displaying one or more items for selection thereof based in part on a portion of a string, the intelligent assistance box has at least one entry corresponding to an element of the schema.

2. The system of claim 1, further comprising an object data intelligent assistance component that provides intelligent assistance functionality for at least one object type related to the schematized data.

3. The system of claim 2, the schematized data intelligent assistance component provides intelligent assistance box content for at least one member related to a type of the schematized data and the object data intelligent assistance component provides box content for at least one class, type, or method of the object type.

4. The system of claim 1, further comprising a development environment for writing software applications that requests intelligent assistance data from the schematized data intelligent assistance component.

5. The system of claim 4, the development environment requests the intelligent assistance data based on a trigger character sequence input.

6. The system of claim 4, the development environment sends software application context information with the request.

7. The system of claim 6, the schematized data intelligent assistance component utilizes the context information to query the schema, at least one intelligent assistance box entry corresponds to a result of the query.

8. The system of claim 1, further comprising a schematized data flow management component that preserves an intelligent assistance context throughout one or more program elements.

9. The system of claim 1, further comprising a navigation matching component that at least one of filters or orders intelligent assistance box entries based in part on a property partition list related to the individual entries.

10. The system of claim 1, further comprising a schema caching component that caches one or more schemas, the schema caching component updates its cache based at least in part on window focus of an application requesting intelligent assistance functionality.

11. A method for providing intelligent assistance functionality for schematized data, comprising:
compiling one or more schemas;
navigating the one or more schemas based in part on a program context from a program development environment; and
providing intelligent assistance data related to one or more elements of the one or more schemas to the program development environment, the intelligent assistance data facilitates displaying one or more items that completes an expression based in part on a portion of a string.

12. The method of claim 11, further comprising providing intelligent assistance data related to one or more object types corresponding to a type of the schema.

13. The method of claim 11, the program context relates to at least one specified type in the schema.

14. The method of claim 13, the schema is queried for the specified type and the intelligent assistance data comprises disparate types related to the specified types in the schema.

15. The method of claim 1 1, the intelligent assistance data relates to a trigger character sequence input in the program development environment.

16. The method of claim 11, further comprising analyzing an expression context to preserve dataflow of the intelligent assistance data.

17. The method of claim 16, the expression context relates to at least one variable of the expression that has an assigned value corresponding to a type of the one or more schemas.

18. The method of claim 11, further comprising generating intelligent assistance data lists for the one or more schemas and merging the lists based in part on a data similarity.

19. The method of claim 1 1, further comprising caching the one or more schemas for more efficient access, the cache is updated based in part on a window focus event in the program development environment.

20. A system for providing intelligent assistance functionality that facilitates displaying one or more items for selection thereof based in part on a portion of a string in a development environment, comprising:
means for formulating an intelligent assistance data list related to schematized data;
means for formulating an intelligent assistance data list related to object type data; and
means for selecting which list to formulate based in part on one or more characters input into the development environment.
